(19) United States
(12) Patent Application Publication
(10) Pub. No.: US 2007/0176846 A1
(43) Pub. Date: Aug. 2, 2007

(54) Radiation controller including reactive elements on a dielectric surface

(75) Inventors: Javier Vazquez, Madrid (ES); Robert A. Pearson, Surrey (GB)

Correspondence Address: WELSH & FLAXMAN LLC, 2000 DUKE STREET, SUITE 100, ALEXANDRIA, VA, 22314, US

(73) Assignee: ERA PATENTS LIMITED, Surrey (GB)

(21) Appl. No.: 10/565,598

(22) PCT Filed: Aug. 18, 2004
(86) PCT No.: PCT/GB04/03548

§ 371 Date: Jul. 28, 2006

(30) Foreign Application Priority Data
Aug. 19, 2003 (EP) 03255134.3

(51) Int. Cl. H01Q 15/02

(52) U.S. Cl. 343/909; 343/872

(57) ABSTRACT

A device for controlling electromagnetic radiation emitted by a structure is described. The device has a reactive element comprising an array of conductors disposed on a dielectric surface such that the displacement between a conductor and any other conductor adjacent to it is small compared to the wavelength of the electromagnetic radiation. As such, the array of conductors represents an effectively continuous conductive surface to the electromagnetic radiation and the surface impedance of the conductive surface (2) is reactive.

This invention relates to a device for controlling electromagnetic radiation emitted by a structure and, in particular, to electromagnetic radiation emitted by an antenna. The device may also be used in the construction of chokes.

Waveguides with apertures for use as antennas are well known. For example, chapter 17, pages 26 to 27 of “Antenna Handbook” by Y T Lo and S W Lee published by Van Nostrand Reynolds in 1988 describes a planar waveguide array in which the beam angle of the emitted radiation can be scanned by varying the frequency of that radiation.

Another example of a waveguide with an aperture is given in “Partially Reflecting Sheet Arrays” by G von Trentini published in IRE Transactions on Antennas and Propagation in October 1956. This discusses the radiation pattern of multiply reflected electromagnetic waves propagating between a partially reflecting sheet and a plane. The partially reflecting sheet may be a perforated or wire grid. These waveguide apertures are all of the same order of magnitude as the wavelength of the electromagnetic radiation with which they are designed to operate. Hence, the minimum size of these waveguide antennas is limited to being of a similar order of magnitude to the wavelength at which they operate. Further disadvantages of these structures are that they can only operate with a single polarization at a time.

In accordance with one aspect of the present invention, there is provided a device for controlling electromagnetic radiation emitted by a structure, the device having a reactive element comprising an array of conductors disposed on a dielectric surface such that the displacement between a conductor and any other conductor adjacent to it is small compared to the wavelength of the electromagnetic radiation thereby causing the array of conductors to represent an effectively continuous conductive surface to the electromagnetic radiation, wherein the surface impedance of the conductive surface is reactive.

This type of device allows for compact waveguide structures to be created due to the fact that the displacement between conductors is small compared to the wavelength of the electromagnetic radiation. It also has the advantage that more than one polarization can be controlled simultaneously. The device allows at least two novel antennae and a novel choke to be constructed, as will be described hereinafter. By small compared to the wavelength of the electromagnetic radiation, we mean, for example, one tenth or one hundredth of the wavelength although, experimentation has shown that the smaller the displacement between conductors the higher the performance of the device.

Typically, the dielectric surface of the reactive element is planar although alternatively, it may be a surface that is curved in one or more dimensions.

The electromagnetic radiation controlled by the device may have one wavelength or it may have more than one wavelength. For example, a carrier wave may be modulated by a modulating wave such that the radiation to be controlled occupies a range of frequencies. Similarly, the device may be used with radiation of just one polarization or indeed, with more than one polarization.

The surface impedance of the reactive element of the device may be inductive or it may be capacitive. Another alternative is that the reactive element may have a capacitive surface impedance in some regions of the dielectric surface and an inductive surface impedance in the remaining regions of the dielectric surface.

The device may be configured such that the magnitude of the surface impedance of the reactive element is constant at all positions on the dielectric surface. Alternatively, it may be configured such that the magnitude of the surface impedance of the reactive element varies at different positions on the dielectric surface.

In a preferred embodiment, the conductors of the reactive element are substantially periodically disposed with respect to each other on the dielectric surface.

The device allows various novel structures to be constructed. In a second aspect of the invention, an antenna comprises a conductive equipotential surface; a device according to the first aspect of the invention, the reactive element of which is disposed parallel to the equipotential surface; an emitter for emitting electromagnetic radiation that is guided between the equipotential surface and the reactive element; and an actuating mechanism for adjusting the displacement between the equipotential surface and the reactive element so that the angle of propagation of a beam of electromagnetic radiation that leaks through the reactive element can be varied.

A variety of emitters may be used with such an antenna but typically, the emitter is a dual polarization collimated source or alternatively a dual polarized planar feed or a conformal array feed.

The actuating mechanism used to adjust the displacement between the equipotential surface and the reactive element typically comprises a hydraulic actuator, a piezoelectric actuator or an electric motor.

This antenna may be used in a variety of ways. For example, it enables a method of directing a beam of electromagnetic radiation using an antenna according to the second aspect of the invention, the method comprising causing the emitter to emit electromagnetic radiation; guiding the electromagnetic radiation between the equipotential surface and the reactive element; and adjusting the displacement between the equipotential surface and the reactive element using the actuating mechanism so that the angle of propagation of the beam of electromagnetic radiation that leaks through the reactive element is set to a predetermined value.

It also enables a method of scanning a beam of electromagnetic radiation using an antenna according to the second aspect of the invention, the method comprising causing the emitter to emit electromagnetic radiation; guiding the electromagnetic radiation between the equipotential surface and the reactive element; and cyclically varying the displacement between the equipotential surface and the reactive element using the actuating mechanism so that the angle of propagation of the beam of electromagnetic radiation that leaks through the reactive element oscillates between two values.

In accordance with a third aspect of the present invention, an antenna comprises a conductive equipotential surface; a device according to the first aspect of the invention, the reactive element of which is disposed parallel to the equipotential surface; an emitter for emitting electromagnetic radiation that is guided between the equipotential surface and the reactive element; and a layer of active dielectric material disposed between the equipotential surface and the reactive element wherein the angle of propagation of a beam of electromagnetic radiation that leaks through the reactive element can be varied by adjusting a biassing potential across the layer of active dielectric material.

This antenna may further comprise an actuating mechanism for adjusting the displacement between the equipotential surface and the reactive element so that the angle of propagation of the beam of electromagnetic radiation that leaks through the reactive element may be varied. In this case, the actuation mechanism may comprise a hydraulic actuator, a piezoelectric actuator or an electric motor.

Various different types of emitter may be used with this invention. For example, the emitter may be a dual polarization collimated source or it may be a dual polarized planar feed or a conformal array feed.

Various types of active dielectric material may be used. One such material is titanium dioxide.

In common with the second aspect of the invention, the antenna according to the third aspect of the invention enables a method of directing a beam of electromagnetic radiation using an antenna. According to the third aspect of the present invention, the method comprises causing the emitter to emit electromagnetic radiation; guiding the electromagnetic radiation between the equipotential surface and the reactive element; and adjusting the biassing potential across the equipotential surface and the reactive element so that the angle of propagation of the beam of electromagnetic radiation that leaks through the reactive element is set to a predetermined value.

The antenna according to the third aspect of the invention further enables a method of scanning a beam of electromagnetic radiation. The method comprises causing the emitter to emit electromagnetic radiation; guiding the electromagnetic radiation between the equipotential surface and the reactive element; and cyclically varying the biassing potential across the equipotential surface and the reactive element so that the angle of propagation of the beam of electromagnetic radiation that leaks through the reactive element oscillates between two values.

In accordance with a fourth aspect of the present invention there is an antenna comprising a conductive cavity, one boundary of which comprises a first device according to the first aspect of the invention, the reactive element of which is adapted to present a capacitive surface impedance; and an emitter disposed within the cavity for emitting electromagnetic radiation.

In one embodiment, a boundary of the cavity opposite the reactive element of the first device is an equipotential surface. In another embodiment, the boundary of the cavity opposite the reactive element of the first device comprises a second device according to the first aspect of the invention, the reactive element of which is adapted to present a capacitive surface impedance.

The cavity of this antenna may be formed using a printed circuit board substrate with the first device being printed on the top layer of the substrate and plated through holes connecting the top layer to the bottom layer which forms the opposite boundary, the plated through holes thereby forming the sides of the cavity.

In this case, the emitter may be printed on an inner layer of the substrate.

In accordance with a fifth aspect of the invention, there is provided a choke comprising a conductive cavity, one boundary of which is formed by a set of annular concentric devices according to the first aspect of the invention with regions of dielectric disposed therebetween.

The invention will now be described with reference to the accompanying drawings, in which:

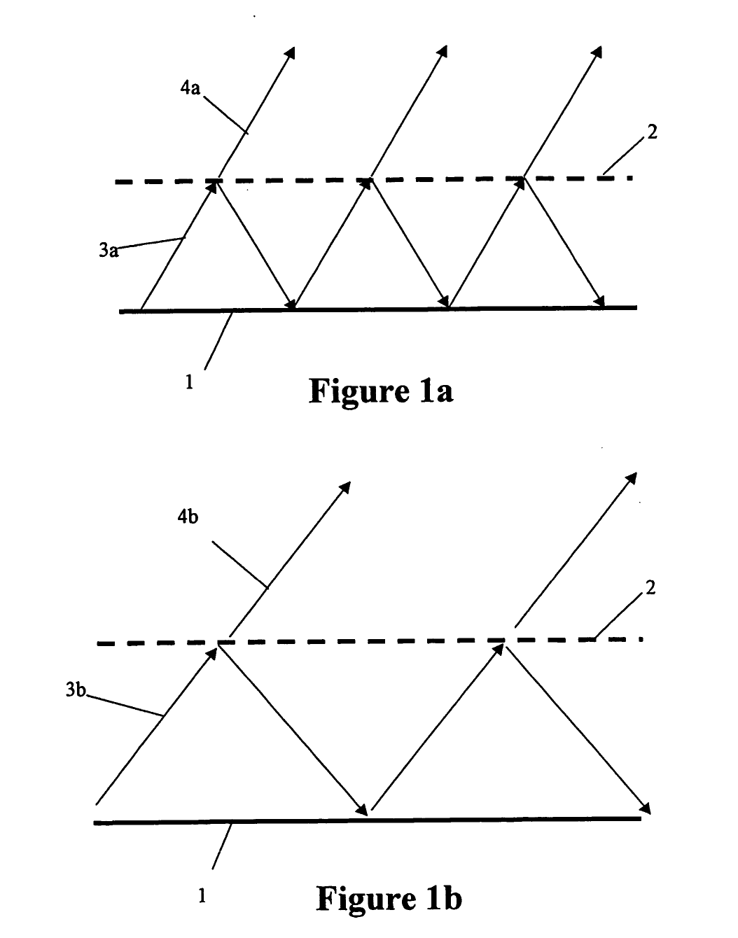

FIGS. 1a and 1b show guided and radiated waves in a first embodiment of the invention;

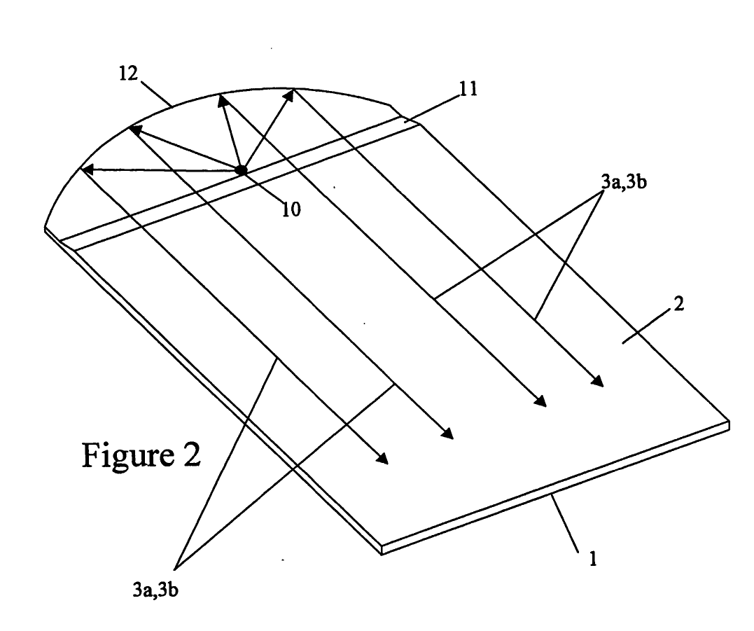

FIG. 2 shows one type of emitter that can be used to introduce electromagnetic radiation into the antenna according to the first embodiment;

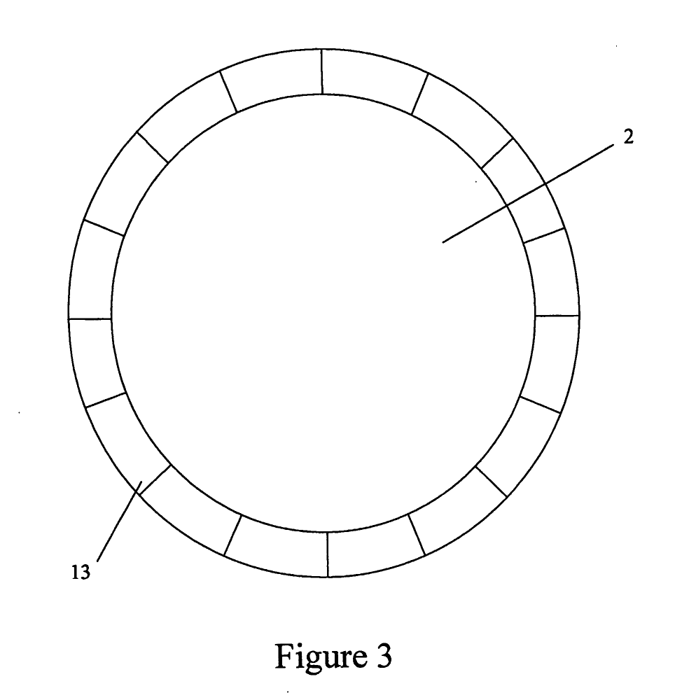

FIG. 3 shows an arrangement for varying the azimuthal plane in which a beam of radiation is formed using the antenna of the first embodiment;

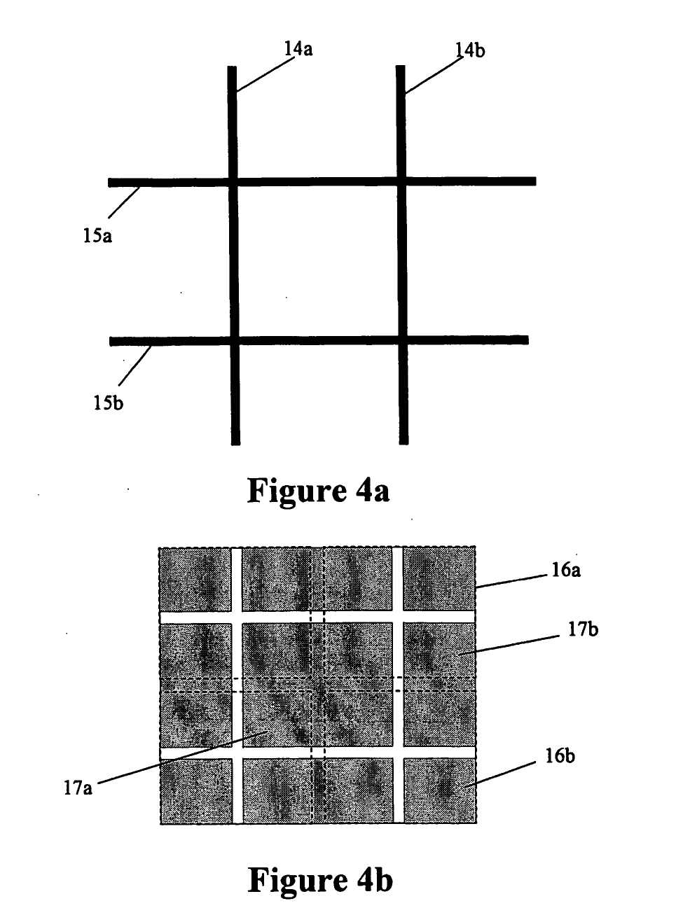

FIGS. 4aand 4b show sample reactive surfaces exhibiting inductive and capacitive surface impedances;

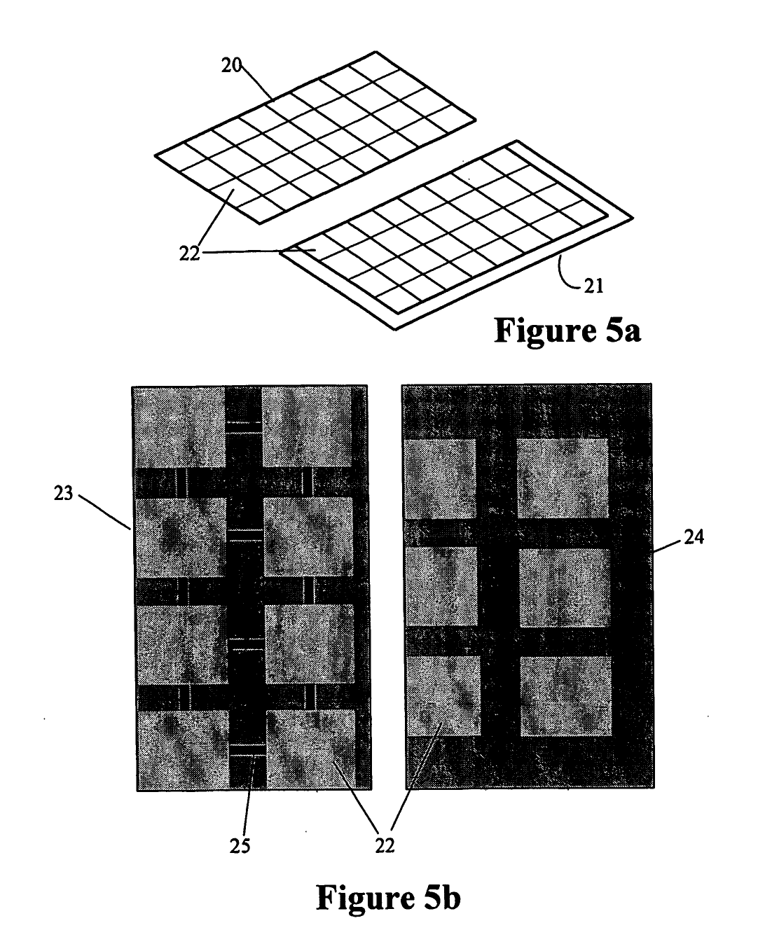

FIGS. 5a and 5b shows two possible structures for producing an antenna according to a second embodiment of the invention;

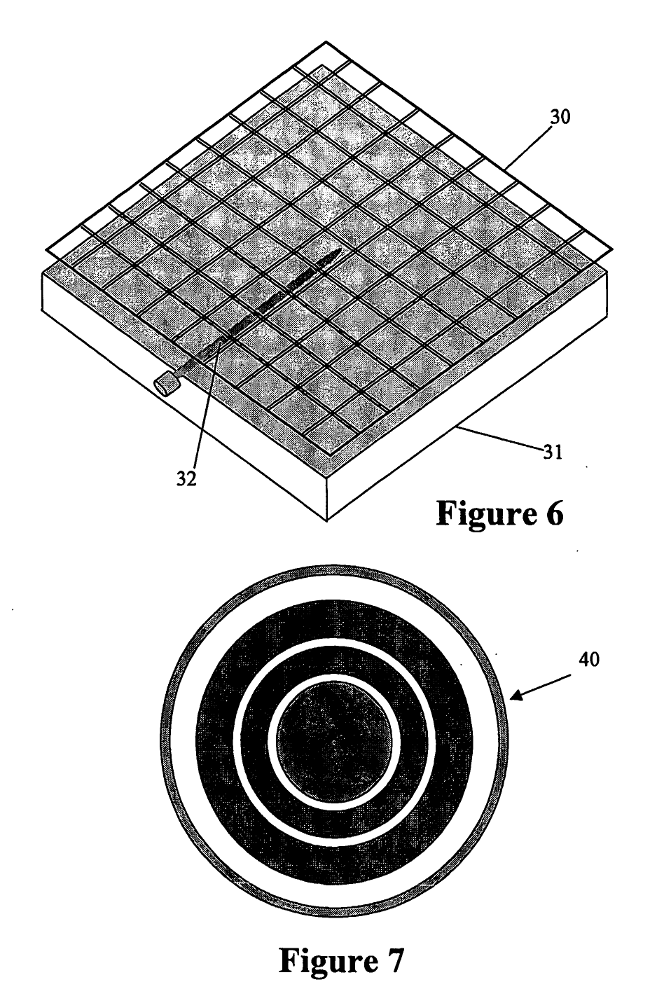

FIG. 6 shows a cavity antenna according to the second embodiment; and

FIG. 7 shows a third embodiment of the invention in which a choke is realised.

FIGS. 1a and 1b show a first embodiment, in which an antenna comprises two parallel flat plates. One plate is a metallic ground plane 1 and the other is a reactive surface impedance plane 2. Typically, the reactive surface impedance plane 2 is realised as a close-coupled printed periodic structure on a thin dielectric substrate. For example, it may be printed on one side of a printed circuit board substrate as indeed, may the metallic ground plane 1. The periodic structure may be in the form of a lattice, each element of which is separated by a distance much smaller than the wavelength of the electromagnetic radiation.

The two parallel plates 1,2 are used to guide electromagnetic waves 3a,3b in between them. The guided electromagnetic waves 3a,3b may have two polarisations and the phase velocity of the waves is controlled simultaneously for both polarisations by the separation between the planes 1,2. Electromagnetic waves 4a,4b are radiated from the antenna by leakage of the guided waves 3a,3b through the reactive surface impedance plane 2. The radiated waves 4a,4b produce a pencil radiation beam along the direction of propagation of the guided waves 3a,3b. The angle subtended by the radiated waves 4a,4b with respect to the normal to the antenna is a direct function of the propagation constant of the guided waves 3a,3b. As a result, the antenna can be used as a scanning antenna, with the scan angle of the radiated waves 4a,4b being controlled by the separation between planes 1,2.

In effect, the reactive surface impedance plane 2 acts as a semi-transparent screen. Its “transparency” is controlled by the magnitude of the reactive surface impedance.

The separation between the ground plane, and the reactive surface impedance plane 2 can be controlled by use of any means (not shown), including piezoelectric or hydraulic actuators or an electric motor. The cavity between the reactive surface impedance plane 2 and the ground plane 1 can be partially filled or indeed, completely filled when the two planes 1,2 are at the minimum separation, with a dielectric.

It is also possible to coat or to apply periodic features to the ground plane 1 to control the propagation coefficient of the antenna and hence the scan angle for a given separation. Suitable periodic features may be, for example, electrically small rectangular posts distributed periodically over the ground plane.

Active dielectric materials, for example a ferroelectric material such as titanium dioxide, can also be placed between the ground plane 1 and the reactive surface impedance plane 2 providing that the electrical properties of the material are such that an electromagnetic wave can propagate in the material. The effective permittivity of the active dielectric material can be varied by adjusting a biassing potential applied to the material. As such, the beam can be scanned without the need for a physical change in the separation between the two planes 1,2. In practice, the biassing potential will be applied across the reactive surface impedance plane 2 and the ground plane 1, which will be in electrical contact with the active dielectric material. The angle of propagation of the beam can be fixed by applying a dc biassing potential or scanned by cyclically varying the biassing potential.

The two planes 1,2 can guide electromagnetic waves of two desired polarisations in between them. The guided waves 3a,3b propagate in a direction parallel to the planes 1,2 as plane waves which suffer multiple reflections between the planes 1,2. The angle of reflection needed to produce a guided wave 3a, 3b is a function of the separation between the planes 1,2 and the surface impedance. As can be seen from FIGS. 1a and 1b, the angle of reflection is inversely proportional to the separation between the planes 1,2. In particular, the separation of the planes 1,2 is greater in FIG. 1b than in FIG. 1a. Hence, the angle of reflection of the guided waves 3a,3b is lower in FIG. 1b than in FIG. 1a.

The reactive surface impedance plane 2 allows some of the electromagnetic radiation to pass through it. As a result, an electromagnetic wave 4a,4b is radiated as a plane wave. The intensity of the radiated wave 4a,4b depends on the “transparency” of the reactive surface impedance plane 2. Generally speaking, the intensity is proportional to the magnitude of the reactive surface impedance. The angle between the normal to the reactive surface impedance plane 2 and the direction of propagation of the radiated wave 4a,4b is similar to the angle of reflection of the guided waves 3a,3b if the space between the plane 1,2 is air-filled. As can be seen from FIGS. 1a and 1b, the angle between the normal to the reactive surface impedance plane 2 and the radiated waves 4a,4b is greater when the separation of the planes 1,2 is increased.

As shown in FIG. 2, the electromagnetic waves 3a,3b are excited using a dual polarization collimated source 10. A conductive flexible section 11 connects two planes 1,2 to a fixed metallic parallel plate parabolic reflector 12 that is used to reflect the electromagnetic waves produced by the source 10 into the radiating part of the antenna. This produces a wave with a flat wave front across the antenna aperture between the two planes 1,2.

FIG. 3 shows another arrangement in which an array of feeds 13 is disposed around the periphery of the cavity formed between the ground plane 1 and the reactive surface impedance plane 2. By exciting a subset of feeds with the appropriate phase, it is possible to form a beam or several beams in any azimuthal plane.

The antenna can also be configured with a single or multiple feed using a folded parallel plate configuration, although this generally restricts optimum performance to only one polarization at a time.

The reactive surface impedance plane 2 is normally realised in practice as a periodic distribution of metal on a surface. Alternatively, metal can be combined with slabs of dielectric to realise the surface. The metal can be arranged in one or more close-coupled layers. That is to say that the separation between layers is much smaller than the wavelength of the electromagnetic radiation, for example 1/100 of a wavelength or less. In order to ensure the desired properties are achieved, the periodicity of the metal must be much smaller than the wavelength, for example 1/20 of a wavelength or smaller. Examples of periodic structures emulating an ideal reactive surface impedance are shown in FIGS. 4a and 4b. The dielectric layer provides mechanical rigidity and environmental protection. The surface impedance relates the tangential electric field on the surface to the superficial currents flowing in the surface as a result as shown by equation 1.
Y̅ₛ\vec{E}ₜ=\hat{n}×(\vec{H}₂₋\vec{H}₁)=\vec{j}ₛ (Equation 1)

In equation 1, \vec{E}ₜ is the electric field vector that is tangential to the reactive surface impedance plane 2, \vec{Y}ₛ is the surface admittance 2×2 matrix (or tensor) for the structure, \hat{n} is the unit vector which is normal to the reactive surface impedance plane 2, \vec{H}₁ and \vec{H}₂ represent the magnetic fields on each side of the reactive surface impedance plan 2 and \vec{j}ₛ is the electric current density flowing on the surface of the reactive surface impedance plane 2.

Since the periodicity of the structures shown in FIGS. 4a and 4b is small compared to the wavelength of the guided waves 3a,3b, the structures appear effectively continuous to the electromagnetic radiation and so, the ideal conditions of Equation 1 are valid.

FIG. 4a shows part of a structure comprising a lattice of conductors 14a,14b,15a,15b. Conductor 14a is connected to conductors 15a,15b at their respective junctions. Conductor 14b is similarly connected. This structure realizes an inductive surface impedance.

FIG. 4b shows part of a structure used to realise a capacitive surface impedance. The structure comprises conductive squares 16a,16b,17a,17b. or a substrate. The conductive squares 16a,16b (in dashed lines) are on the bottom of the substrate whilst the conductive squares 17a,17b (shaded in FIG. 4b) are on the top of the substrate. The conductive squares 16a,16b,17a,17b effectively form the plates of capacitors.

The antenna uses the modes TM₁ and TE₁, which propagate with relatively similar phase velocity but at orthogonal linear polarisations to produce two beams. These beams will scan at almost identical angles, as the modes support two orthogonal linear polarisations. The mode TM₀ can also be used to generate a third beam with similar polarization as the TM₁ mode, but with a large difference in scan angle. As a result, the propagation of TM₀ waves in the structure must be suppressed. The feeding array 13 or reflector 12 can be configured to excite modes TM₁ and TE₁, but avoid the generation of mode TM₀. The conversion between TM modes can be minimized by keeping symmetry everywhere in the structure.

The parallel plate structure of the two planes 1,2 can propagate several electromagnetic waves or modes. Under normal operation, the structure will support the modes TM₀, TM₁, TE₁ with propagation constants given by equations 2a and 2b.

$$\begin{matrix}{jY}_{0} \frac{{k}_{y}}{k} cot ( {k}_{y} h ) = {Y}_{S}^{TE} + {Y}_{L}^{TE} & ( TE modes , Equation 2 a ) \\ {jY}_{0} \frac{k}{{k}_{y}} cot ( {k}_{y} h ) = {Y}_{S}^{TM} + {Y}_{L}^{TM} & ( TM modes , Equation 2 b )\end{matrix}$$

In equations 2a and 2b, Y₀ represents the admittance of free space, Y_{S}^{TE} and Y_{S}^{TM} are the surface admittance of the reactive surface impedance plane 2 for transverse electric and transverse magnetic waves respectively, Y_{L}^{TE} and Y_{L}^{TM} are the admittance of the half-space above the reactive surface impedance plan into which the antenna radiates (including the contribution of any additional layers used to support the plane 2) for transverse electric and transverse magnetic waves respectively, k is the separation between the ground plane 1 and the reactive surface impedance plane 2, and k_{y} is the complex propagation constant of the radiated wave.

The surface impedance of the reactive surface impedance plane 2 can be chosen to compensate for the differences in scan angle and leakage rate between polarisations (modes TM₁ and TE₁). This is achieved by introducing some asymmetry in the dimensions (longitudinal and transverse) of the periodic metallic pattern utilized to realise the reactive surface impedance plane 2. The surface impedance can be varied along the aperture of the antenna, starting with a low value and increasing it to enhance the “transparency” of the plane 2 as the waves propagate through the structure. As a result, if the surface impedance profile is properly optimized, the distribution of power at the antenna aperture is compensated to reduce the sidelobe level of the antenna radiation pattern.

Instead of rotating the whole antenna around an axis perpendicular to the two planes 1, 2, (i.e. in an azimuthal orientation), the antenna can be configured so that the two planes 1,2 are fixed in space, but the feeding structure is rotated to scan the beam. This has many advantages in terms of integration of the antenna with a variety of platforms and enables the reactive surface impedance plane 2 to form a fixed protective radome ensuring that environmental, structural, scattering and cost characteristics can all be optimized. Some limitation in the electrical performance characteristics of this alternative implementation arise owing to the need for a symmetrical leakage rate across the reactive surface impedance plane 2.

The second embodiment of the invention relates to an antenna that comprises a cavity with its limiting surface made of metal, which is non-transparent to electromagnetic waves, and a reactive surface impedance plane, which is partially transparent to electromagnetic fields. The electromagnetic energy inside the cavity is radiated into the air through the reactive surface impedance planes. The reactive surface impedance plane is normally designed to be highly capacitive at the frequency band of operation. The capacitance coupled with the inductive fields inside the cavity produces an evanescent wave inside the cavity. As a result, this cavity antenna has a very small electrical size and can operate without using high dielectric constant materials. The highly reactive surface impedance plane is typically realised using metal patches printed periodically on both sides of a dielectric sheet in the same way as in the first embodiment.

The metal cavity is typically of rectangular or cylindrical cross-section with one or more of the boundary walls of the cavity realised using a highly reactive surface impedance structure.

FIG. 5a shows suitable patterns for printing the top side 21 and bottom side 20 of a substrate to realise a capacitive surface impedance. The metal squares 22 effectively form the plates of the capacitors and the squares 22 on the top side 21 are offset with respect to those on the bottom side 20.

FIG. 5b shows another arrangement. In this, top side 24 of the substrate has metal squares 22 in the same manner to top side 21 shown in FIG. 5a. However, bottom side 23 has metal squares 22 that are joined by linking conductors 25. These effectively join each pair of capacitive plates formed by metal squares 22 with an inductance. The periodicity of the metal squares 22 is much smaller than the wavelength of operation. Typically, it is less than one-tenth of a wavelength and, in some cases it may approach one-hundredth of a wavelength. As a consequence of this small size, the electromagnetic field is only affected by the average electrical properties of the reactive surface impedance plane, and it is possible to represent the structure as a continuous one with an equivalent value of surface impedance as defined by equation 1.

Unlike the structure shown in FIG. 5a which is purely capacitive, the structure shown in FIG. 5b provides a resonant (inductive—capacitive) surface impedance. Hence, the structure of FIG. 5b provides a frequency selective response that can be used in a number of ways, for example, as part of a rejection filter or to enhance the reflectivity of the antenna outside its operating band.

The reactive surface impedance plane is designed to present a high surface capacitance in the operating band. The cavity is much smaller than the wavelength in the operating band and so, the cavity behaves as an inductance storing magnetic energy. The high capacitance of the reactive surface impedance plane stores electrical energy and resonates with the cavity. As a consequence, the resulting fundamental cavity mode is an evanescent wave rather than a standing wave. In a metallic rectangular cavity in which the top wall is a reactive surface impedance plane 30 as shown in FIG. 6, the electric field associated with the fundamental evanescent mode is described by equation 3.

$$Ey = {A}_{o} ( \frac{π}{ɛ a} ) sin ( \frac{π}{a} x ) sinh ( α z ) \qquad Equation 3$$

where a is the longest dimension of the cavity (normally along the x axis);
α_{z} defines the evanescent decay of the wave inside the cavity.

The z axis is directed along the cavity depth. The parameter, α_{z} is linked to the resonant frequency of the mode in the cavity that defines the frequency of operation of the antenna. In the case of the fundamental mode of a rectangular cavity, the parameter α_{z} and the frequency of resonance, fᵣₑₛ, can be obtained by solving equations 4 in particular by eliminating the cavity eigenvalue parameter, α₂.

$${f}_{res} = \frac{j {α}_{z}}{2 πμ} {Z}_{s} {tanh}^{- 1} ( {α}_{z} c ) \\ {f}_{res} = \frac{1}{2 π \sqrt{μɛ}} \sqrt{{( \frac{π}{a} )}^{2} - {α}_{z}^{2}} \qquad Equation 4$$

where Zs is the surface impedance of the semitransparent layer and c is the cavity depth.

Unlike the approach presented by the von Trentini document already cited, the usage of highly reactive, close-coupled, printed structures is intended to produce evanescent, cut off waves inside the cavity as described by equation 3 and 4, rather than propagating waves. One advantage of this approach compared to the work described by von Trentini is the radical change in the relationship between cavity size and frequency of operation, which is implicit in equation 4 for the particular case of a rectangular cavity. The approach presented here does not require that the depth of the cavity must be about half a wavelength. In fact, there is no limit to the minimum cavity depth for a given frequency of operation.

Besides the depth, the other dimensions of the cavity can also be much smaller than half a wavelength. A typical air-filled cavity size for a bandwidth of 5% is about a quarter of a wavelength with a cavity depth of one-twentieth of a wavelength. For a bandwidth of 1%, the air filled cavity size can be reduced to one-eighth of a wavelength with a cavity depth of one-fortieth of a wavelength. Any frequency of operation can be achieved with this approach, no matter how small the antenna and how low the frequency is. However, the bandwidth of the antenna is proportional to the volume of the cavity. This is a direct consequence of the increase in the Q factor of the cavity as the size becomes smaller.

The cavity can be excited using one or more probes, which are parallel to the reactive surface impedance plane 30. Several probes can be used to generate circular polarization, since the fundamental evanescent wave is typically linearly polarized. These probes can be printed, forming part of a microstrip or stripline circuit or they can be connected to coaxial transmission lines that are used as antenna ports. Another possible type of feeding employs a U-shaped slot with a microstrip line or stripline to excite it from below.

The implementation of the antenna shown in FIG. 6 has a rectangular cavity 31, a reactive surface impedance plane 30 and a coaxial probe 32.

The antenna shown in FIG. 6 can be made using multilayer printed circuit manufacturing techniques. The reactive surface impedance plane 30 can be etched on the top two layers of a printed circuit board with a ground plane printed on the bottom layer and the feeding probe 32 printed on an inner layer. The cavity 31 itself can be formed using plated through holes connecting the reactive surface impedance plane 30 to the ground plane rather than solid metal walls.

Besides conventional printed circuit techniques, the cavity antenna can be made using ceramic-based technologies such as Low Temperature Co-fired Ceramics (LTCC), in order to integrate the antenna with active RF circuits or for applications having harsh operating environments.

This type of antenna produces a broad radiation pattern that is well suited for low gain applications with hemispherical coverage. Unlike convoluted patch antennas, the quality of the pattern is good even considering the very small electrical size of the antenna, since the rectangular or circular shape of the structure does not need to be altered or twisted, only its dimensions are reduced.

This antenna is easily integrated into a shallow recess in a ground plane, typically of only a few millimetres depth. The recess can be covered by the reactive surface impedance plane 30. As a result, the antenna does not need to protrude above the ground plane level. This is an ideal situation for applications on mobile platforms such as vehicles and aircraft where aesthetics, space, and drag are important factors. Military radar applications may also benefit from the low scattering of this type of antennas.

This antenna is also well suited for use as an array element. The antenna can be electrically small, so the elements of the array can be closely packed together with the beamformer network placed in between the radiating elements. Unlike patch antennas, this approach does not require dielectric materials or substrates that may propagate surface waves and are prone to mutual coupling since each antenna element is enclosed in its own cavity. This antenna element is therefore attractive for phased array applications due to its small size and reduced mutual coupling.

Furthermore, higher order resonances can be controlled by placing pins inside the cavity.

In the third embodiment, a highly reactive surface impedance plane is used to realise a low profile choke, which is particularly useful for antenna configurations mounted in grid planes. Such chokes can be used to improve the circular radiation pattern symmetry of the antenna. The shape of the cavity can be configured to control the antenna radiation pattern properties and the scattering characteristics of the antenna.

An example of such a choke 40 is shown in FIG. 7. The choke structure consists of a number of printed metallic rings backed by coaxial cavities. The metal ring structure makes the average phi component of the electric field zero on the surface of the choke. At the frequency of operation the metal rings and the back cavity resonate, creating a condition in which the average phi component of the magnetic field becomes zero. This means that the radial electric currents flowing are stopped at the choke which behaves as an open circuit at resonance. This symmetrical boundary condition simultaneously causes the phi component of the electric and magnetic field to be zero, creating the necessary conditions to obtain a rotationally symmetric antenna radiation pattern with linear polarization.

A simple ground plane only cancels the phi component of the electric field at the surface. As a result, the radiation of a linearly polarized antenna is not rotationally symmetric because the boundary condition imposed is different in the planes parallel to and perpendicular to the polarized field.

1. A device for controlling electromagnetic radiation emitted by a structure, the device having a reactive element comprising an array of conductors disposed on a dielectric surface such that the displacement between a conductor and any other conductor adjacent to it is small compared to the wavelength of the electromagnetic radiation thereby causing the array of conductors to represent an effectively continuous conductive surface to the electromagnetic radiation, wherein the surface impedance of the conductive surface is reactive.

2. A device according to claim 1, wherein the dielectric surface of the reactive element is planar.

3. A device according to claim 1, wherein the electromagnetic radiation has more than one wavelength.

4. A device according to claim 1, wherein the electromagnetic radiation has more than one polarization.

5. A device according to claim 1, wherein the surface impedance of the reactive element is inductive.

6. A device according to claim 1, wherein the surface impedance of the reactive element is capacitive.

7. A device according to claim 1, wherein the surface impedance of the reactive element is capacitive in some regions of the dielectric surface and inductive in the remaining regions of the dielectric surface.

8. A device according to claim 1, wherein the magnitude of the surface impedance of the reactive element varies at different positions on the dielectric surface.

9. A device according to claim 1, wherein the conductors of the reactive element are substantially periodically disposed with respect to each other on the dielectric surface.

10. An antenna comprising a conductive equipotential surface; using a device for controlling electromagnetic radiation emitted by a structure, the device having a reactive element comprising an array of conductors disposed on a dielectric surface such that the displacement between a conductor and any other conductor adjacent to it is small compared to the wavelength of the electromagnetic radiation thereby causing the array of conductors to represent an effectively continuous conductive surface to the electromagnetic radiation, wherein the surface impedance of the conductive surface is reactive, the reactive element of which is disposed parallel to the equipotential surface; an emitter for emitting electromagnetic radiation that is guided between the equipotential surface and the reactive element; and an actuating mechanism for adjusting the displacement between the equipotential surface and the reactive element so that the angle of propagation of a beam of electromagnetic radiation that leaks through the reactive element can be varied.

11. A method of directing a beam of electromagnetic radiation using an antenna according to claim 10, the method comprising causing the emitter to emit electromagnetic radiation; guiding the electromagnetic radiation between the equipotential surface and the reactive element; and adjusting the displacement between the equipotential surface and the reactive element using the actuating mechanism so that the angle of propagation of the beam of electromagnetic radiation that leaks through the reactive element is set to a predetermined value.

12. A method of scanning a beam of electromagnetic radiation using an antenna according to claim 10, the method comprising causing the emitter to emit electromagnetic radiation; guiding the electromagnetic radiation between the equipotential surface and the reactive element; and cyclically varying the displacement between the equip potential surface and the reactive element using the actuating mechanism so that the angle of propagation of the beam of electromagnetic radiation that leaks through the reactive element oscillates between two values.

13. An antenna comprising a conductive equipotential surface; using a device according to claim 1, wherein the reactive element of which is disposed parallel to the equipotential surface; an emitter for emitting electromagnetic radiation that is guided between the equipotential surface and the reactive element; and a layer of active dielectric material disposed between the equipotential surface and the reactive element wherein the angle of propagation of a beam of electromagnetic radiation that leaks through the reactive element can be varied by adjusting a biasing potential across the layer of active dielectric material.

14. An antenna according to claim 13, further comprising an actuating mechanism for adjusting the displacement between the equipotential surface and the reactive element so that the angle of propagation of the beam of electromagnetic radiation that leaks through the reactive element can be varied.

15. An antenna according to claim 14 wherein the actuating mechanism comprises a hydraulic actuator or a piezoelectric actuator, or an electric motor.

16. An antenna according to claim 10, wherein the emitter is a dual polarization collimated source or is a dual polarized planar feed or a conformal array feed.

17. An antenna according to claim 13, wherein the active dielectric material is titanium dioxide.

18. A method of directing a beam of electromagnetic radiation using an antenna according to claim 13, the method comprising causing the emitter to emit electromagnetic radiation; guiding the electromagnetic radiation between the equipotential surface and the reactive element; and adjusting the biasing potential across the equipotential surface and the reactive element so that the angle of propagation of the beam of electromagnetic radiation that leaks through the reactive element is set to a predetermined value.

19. A method of scanning a beam of electromagnetic radiation using an antenna according to claim 13, the method comprising causing the emitter to emit electromagnetic radiation; guiding the electromagnetic radiation between the equipotential surface and the reactive element; and cyclically varying the biasing potential across the equipotential surface and the reactive element so that the angle of propagation of the beam of electromagnetic radiation that leaks through the reactive element oscillates between two values.

20. An antenna comprising a conductive cavity, one boundary of which comprises a first device according to claim 1, the reactive element of which is adapted to present a capacitive surface impedance; and an emitter disposed within the cavity for emitting electromagnetic radiation.

21. An antenna according to claim 20, wherein a boundary of the cavity opposite the reactive element of the first device is an equipotential surface.

22. An antenna according to claim 20, wherein a boundary of the cavity opposite the reactive element of the first device comprises a second device, the reactive element of which is adapted to present a capacitive surface impedance.

23. An antenna according to claim 20, wherein the cavity is formed using a printed circuit board substrate with the first device being printed on a top layer of the substrate and plated through holes connecting the top layer to the bottom layer which forms the opposite boundary, the plated through holes thereby forming the sides of the cavity.

24. An antenna according to claim 23, wherein the emitter is printed on an inner layer of a substrate.

25. An choke comprising a conductive cavity, one boundary of which is formed by a set of annular, concentric devices for controlling electromagnetic radiation emitted by a structure, the concentric devices having a reactive element comprising an array of conductors disposed on a dielectric surface such that the displacement between a conductor and any other conductor adjacent to it is small compared to the wavelength of the electromagnetic radiation thereby causing the array of conductors to represent an effectively continuous conductive surface to the electromagnetic radiation, wherein the surface impedance of the conductive surface is reactive with regions of dielectric disposed therebetween.
